(19) United States
(12) Patent Application Publication
(10) Pub. No.: US 2010/0237719 A1
(43) Pub. Date: Sep. 23, 2010

(54) ELECTROMAGNETIC VIBRATORY GENERATOR FOR LOW FREQENCY VIBRATIONS

(76) Inventors: Zdenek Hadas, Kelc (CZ); Vladislav Singule, Brno (CZ); Cestmir Ondrusek, Brno (CZ); Pavel Fiala, Brno (CZ)

Correspondence Address: Frank L.Laczko, PO Box 509, Allen, TX, 75013, US

(21) Appl. No.: 12/451,373

(22) PCT Filed: May 7, 2008
(86) PCT No.: PCT/CZ2008/000051

§ 371 Date: Mar. 17, 2010

(30) Foreign Application Priority Data
May 9, 2007 (CZ) PV2007-331

(51) Int. Cl. H02K 35/02

(52) U.S. Cl. 310/38

(57) ABSTRACT

Electromagnetic vibration generator for generation of electric energy comprising a movable member (2) member (9) arranged to the frame (1), an excitation circuit (8) attached to the movable member (2) and a coil (7), while the coil (7) and the excitation circuit (8) are movably arranged one towards the other in a way so that the magnetic field of permanent magnet (83) is capable to induce voltage in the coil (7), wherein the flexible member (9) is formed of fixed permanent magnets (4) attached in the frame (1) and of one or more movable permanent magnets (3) attached to the movable member (2) with the excitation circuit (8) provided with the hinge (6) mounted in the case (5), while the excitation circuit (8) is formed of at least one permanent magnet (83) arranged on at least one pole piece (81), for creation of magnetic flux through the coil (7), at the same time the coil (1) is in static manner arranged on the frame (1) toward the excitation circuit (8), around which this moves transversably or vice versa.

### TECHNICAL FIELD

The invention relates to an arrangement of electromagnetic vibration generator for production of electric energy comprising the movable member with the flexible member arranged to the frame, of the permanent magnetic excitation circuit attached to the movable member and the coil, while the coil and the excitation circuit are moveably arranged one towards the other in a way, that the magnetic field of permanent magnet is capable to induce voltage in the coil.

### BACKGROUND ART

For power supply of wireless sensors and other embedded applications are nowadays used primary and secondary galvanic cells. In connection with development of electronics and reducing its energy demands, the usage of some surrounding sources of energy for power supply of wireless sensors and nested applications becomes more and more important.

The form of ubiquitous surrounding energy may be the solar energy, temperature gradient, liquid flow, mechanical vibrations, etc., and this energy may serve as the primary source of energy, convertible to electric energy for supply of a certain autonomous device (e.g. the wireless sensor).

Generally are the sources obtaining energy from surroundings designated as Energy Harvesting devices and in connection with reducing the energy demand of wireless networks the importance of such inexhaustible sources of electric energy for power supply of these sensors increases. At present some sources of electric energy which utilise energy from surroundings are used (solar cells, temperature difference, liquid flows, kinetic energy, etc.). One of the possibilities is also utilisation of kinetic energy of surrounding vibrations. The most suitable source of surrounding energy, at the most of dynamic machinery systems, seems to be mechanical vibrations. Suitability of these vibrations for obtaining electric energy depends on stability of dominant frequency and magnitude of vibrations. Energy from mechanical vibrations of the system is being obtained by means of vibratory generator, whose structure is tuned to exciting vibrations and is optimally designed with respect to the required generated power and other requirements on this device.

For conversion of kinetic energy of vibrations to electric energy are generally used the following physical principles; the piezoelectric effect, electrostatic conversions and electromagnetic induction.

Another potential possibility for conversion of kinetic energy to electric one is utilisation of magnetostrictive materials. Nevertheless this principle is not mentioned in any published study known to us concerning possibilities of energy receiving from surroundings.

Generally, any vibratory generator consists of two parts: the resonance mechanism, which upon excitation by vibrations of resonant frequency causes a determinate relative movement, and the generator (so called power converter), in which kinetic energy of excited movement of resonance mechanism is converted into electric energy by implementation of some of already mentioned physical principled.

In recent years the piezoelectric and electrostatic vibratory generator are utilised and they are used as sources of electric energy for power supply of MEMS equipment and miniature wireless sensors. These generators have their specifics and they are used for a low generated power at high frequency of vibrations.

To obtain sufficiency high generated voltage and power, the electromagnetic vibratory generator needs corresponding excited relative movement of resonance mechanism, which will cause a sufficient change of magnetic flux through coil winding and in this winding is therefore induced sufficient electromotive voltage. From this results that for low frequencies of vibrations it is necessary to have a substantially greater value of vibration displacement, and thus a sufficient excited movement of resonance mechanism and sufficient change of magnetic flux in the coil in the electromagnetic vibratory generator may be achieve more easily.

Obtaining of electric energy from vibrations by means of electromagnetic vibratory generator is therefore, advantageous for low frequencies of exciting vibrations, when the amplitude of oscillating movement of vibration is sufficient, this electromagnetic generator may generally be used also for obtaining of electric energy from a general oscillating movement.

Generally, the electromagnetic vibratory generator comprises the following parts: the resonance mechanism, which is formed of flexible member and a movable mass and is tuned to frequency of exciting vibrations (provides a relative movement of exciting circuit against the coil), and the excitation circuit (with FeNdB permanent magnet/magnets), which is a part of the mass of resonance mechanism and forms a suitable magnetic field in the coil /or is a fixed one and a part of resonance circuit is the coil (coils) of armature, which is firmly connected to the frame of generator/or vice versa it is a part of resonance mechanism, but through this the problems with transfer of electric energy by means of movable wires occurs.

Basic principle of electromagnetic vibratory generator for production of electric energy is schematically represented in the FIG. 1 and it is formed by the oscillating movable body having the weight m which is suspended on a flexible member having the stiffness k. Tuning of generator to its own frequency Ω is given by a ratio of stiffness of the flexible member k and the weight of oscillating body m. This combination creates the resonance mechanism and generally it may be structurally achieved through several ways:
Oscillating body is suspended on a flexible member, which may be:
   cylindrical spring,
   profile spring,
   torsion spring,
   special structural variants, e.g. the profile silicon spring (MEMS)
Oscillating body is mounted among a set of repulsing permanent magnets, which create stiffness of the mechanism.
Oscillating body is positioned on the built-in beam.
Oscillating body is positioned on a flexible membrane.
Combination of above mentioned solutions by adding of new structural elements, etc.

Properties of resonance mechanism are influenced by its parameter of mechanical damping bₘ, which is given by the structural arrangement of the resonance mechanism and by used materials. The bₘ parameter affects the excited movement of oscillating mass upon excitation by vibrations, it imparts the quality of the resonance mechanism, and thus affects also the obtained power from the exciting vibration. Resonance mechanism with the lower value of mechanical damping has a greater quality factor and it is able to excite a greater relative movement from the same vibrations and thus to create conditions for obtaining greater generated power.

Next to this, as it is obvious from FIG. 1, the generator is formed by the excitation circuit, creating the magnetic field B in the air gap, where the coil is positioned, and by this coil with inductivity L and inner resistance R_{c}, which is firmly connected with frame of generator, and on which is connected electric load with resistance R_{z}.

The excitation circuit consists of one or several permanent magnets and pole pieces. Arrangement of the whole magnetic circuit of vibratory generator is designed so that in the corresponding air gap was achieved as high value of magnetic field \vec{B} as possible. In this air gap the coil winding is arranged and through the relative oscillating movement of the resonance mechanism towards the frame with the coil an alternating voltage is induced in coil winding. The size of induced voltage depends on the value of magnetic flux and velocity of movement, or on the velocity of change of magnetic flux, mutual position of vector of magnetic flux and the design of the coil and number of coil windings.

It is very important to design suitably the structure of the excitation system and the coil from the point of view of design of resonance mechanism of the generator. The structure of the excitation circuit and of coil is consistent with the structure of resonance mechanism and the structural design of magnetic circuit corresponds to the excited movement of the resonance mechanism. The structure of excitation circuit and of coil is suitably selected according to the size of vibrations and parameters of resonance mechanism.

In case that the generator is loaded with surrounding vibrations having acceleration Aᵥ, which have the same frequency as the tuned up resonance frequency of generator, excitation of the mechanism by vibrations causes the relative oscillating movement x of the body m with respect to the frame of generator with the coil/or vice versa. This movement causes a change of magnetic flux through the coil winding L. On individual windings of the coil, according to the Faraday law on electromagnetic induction, the alternating voltage is induced, which depends on the velocity of excited oscillating movement of magnetic excitation circuit and on the size of time change of magnetic flux through the coil winding and on geometry of the coil.

The value of excited deflection x of the body m, and thus also the value of induced voltage, depends not only on the mechanical damping in generator, but also on the electromagnetic damping, which occurs by dissipating of the electrical power from the system (output power on the load R_{z} and losses in the coil on the resistance R_{c}). Total generated power depends on the ratio of this damping, and it is maximum if the instantaneous value of electromagnetic damping, which is given by structure of excitation circuit, the coil and load, is identical with instantaneous value of mechanical damping, which depends on the structure of resonance mechanism and also on the value of excited movement.

The most suitable machine systems for implementation of vibratory generator as an inexhaustible source of electric energy seems to be helicopters, where the rotor velocity is constant (i.e. also the vibration frequency) during the whole period of machine operation, only the intensity of vibrations is changing. Here positioned and suitably tuned up vibratory generator will be working as a continuous source of electrical energy during the whole machine operation. Utilisation of this device is presumed also at other technical systems like automobiles (generally machine systems), various building structures, bridges, etc.

The best known film dealing with device for obtaining electric energy of mechanical vibrations is Perpetuum Ltd. This company provides vibration energy harvesters for various applications and outputs.

Patent application WO 05022726 A1 discloses the principles of electromagnetic vibration energy harvester, produced by this company. This patent application uses the magnetic circuit fixed on the built-in beam, which together with the magnetic circuit oscillates during excitation by vibrations. During this movement is in the fixed coil, positioned in the air gap of the magnetic circuit, electromotive voltage induced.

To date used structures of resonance mechanism of the vibratory generator have the body with effective mass positioned on the built-in beam or the profile spring, which forms the flexible member. These structural variants exhibit their limits from the point of view of stiffness of the flexible member, and thus of the resonance frequencies of generator. For low resonance frequencies there are necessary relatively soft stiffness characteristics of the flexible member. At usage of traditional materials usage of these structural variants for low frequencies is absolutely unsuitable. Only soft spring in combination with mechanical guiding Of the movable member may be used, which brings further mechanical damping into the system and it means lower generated power. If the flexible member is already used, there is a problem with relatively great deformation of the flexible member at low frequency of excited movement.

### Principle of the Invention

The goal of the invention is to provide solution of electromagnetic vibratory generator using the low frequency of vibrations (as a rule up to 50 Hz, exceptionally up to 100 Hz) for generation of electric energy on the principle of Faraday law of electromagnetic induction.

The above mentioned goal has been achieved through arrangement of electromagnetic vibratory generator for generation of electric energy comprising the movable member and the flexible member arranged to the frame, excitation circuit fixed to the movable member and the coil, while the coil and the excitation circuit are moveably arranged one towards the other in a way, that the magnetic field of permanent magnet is capable to induce voltage in the coil, and whose principle consists in that it has a flexible member formed by the fixed permanent magnets attached in frame and by one or more movable permanent magnets attached to the movable member with the excitation circuit provided with the hinge mounted in case, while the excitation circuit is formed by at least one permanent magnet arranged on at least one pole piece for providing of magnetic flux through the coil, at the same time the coil is in static manner arranged on the frame towards the excitation circuit, around which this moves traversable or vice versa.

The main advantage of arrangement of the electromagnetic vibratory generator may be seen in that, the stiffness in the flexible member of resonance mechanism of vibratory generator is formed by the repulsive permanent magnets. These magnets are with identical poles turned one to another and so they create the repulsive magnetic force. The flexible member formed in this way does not have any material damping and through this generating of higher power is enabled as the generated power depends exclusively on a total mechanical damping of vibratory power generator. The problems with fatigue of material of the flexible member do not exist here, as stiffness of mechanism is provided through magnetic forces only. The advantage of this flexible member is the possibility to newly tuning up of the resonance frequency, that is the working frequency of generator, through a change of distance between the fixed magnets in the frame and the movable magnet on movable member.

It is also advantageous, that the structural arrangement of the hinge case forms precise mechanical guiding for movement of movable member with excitation circuit towards the coil. This mechanical guiding creates the only mechanic damping forces of resonance mechanism. Upon usage of mechanical flexible member, e.g. the spring, it is necessary to use also the mechanical guiding and moreover this member has also further mechanical damping imparted by properties of material, from which it is produced. Out of these reasons the usage of magnetic flexible member with mechanical guiding seems to be as the most advantageous for frequencies of vibrations up to approx. 50-100 Hz.

Rotational mounting of the movable member in bearings is not suitable from the point of view of friction and thus the low sensitivity to the exciting vibrations of such created vibratory generator. Usage of segment rolling bearings is also not usable for vibratory generators due to only oscillating movement around the equilibrium and a due to great loading of these rolling segments exciting the vibrations.

To ensure spot or line contact of case towards the hinge it is advantageous, if the flexible member, which is formed by the fixed permanent magnets fixed in the frame and by one or more movable permanent magnets, through the mutual position of fixed and movable permanent magnets, produces the contact force of the cage towards the hinge. This results in minimisation of mechanical damping forces and increases sensitivity of electromagnetic vibratory generator for excitation by vibrations and enables to generate a greater power.

To reach the above mentioned minimum mechanical damping forces it is advantageous, if execution of the hinge and case is of the following structural arrangement. The hinge is performed as the cylindric pin being rolled in the cylindric case, the hinge is performed as a cylindric pin being rolled in the tapered socket, the hinge is performed as an edge mounted in case with groove, the hinge is performed as a tip mounted in case provided with dent or groove.

### DESCRIPTION OF THE DRAWINGS

The invention shall be explained by means of enclosed drawings, where the

FIG. 1 represents the general scheme of electromagnetic vibratory generator, the

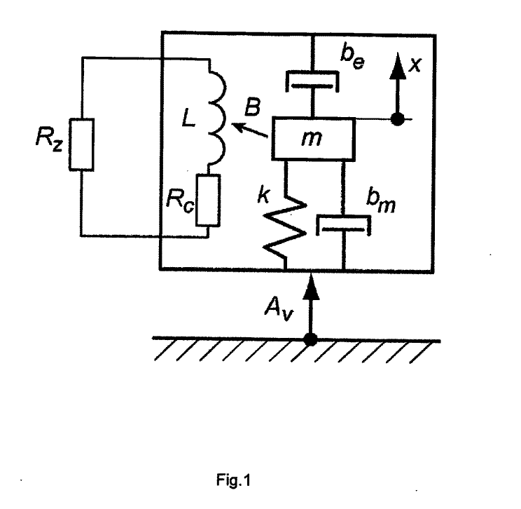

FIG. 2 the structure of vibratory generator for low frequencies of vibrations, the

FIG. 3a and FIG. 3b represent a suitable structural solution for mounting of movable member in the frame and the

FIG. 4 represents used structural solution of excitation circuit with permanent magnets and the coil.

### EXAMPLES OF EMBODIMENT

Arrangement of electromagnetic vibratory generator for production of electric energy will be explained on individual examples of its embodiment. It is obvious, that the below mentioned descriptions are illustrative expressions of applications of principles for this invention.

It is obvious that the whole concept of electromagnetic vibratory generator must be adjusted so that from the given exciting vibrations is generated maximum possible power. This corresponds to the adjustment of parameters of excitation circuit and the coil with parameters of resonance mechanism.

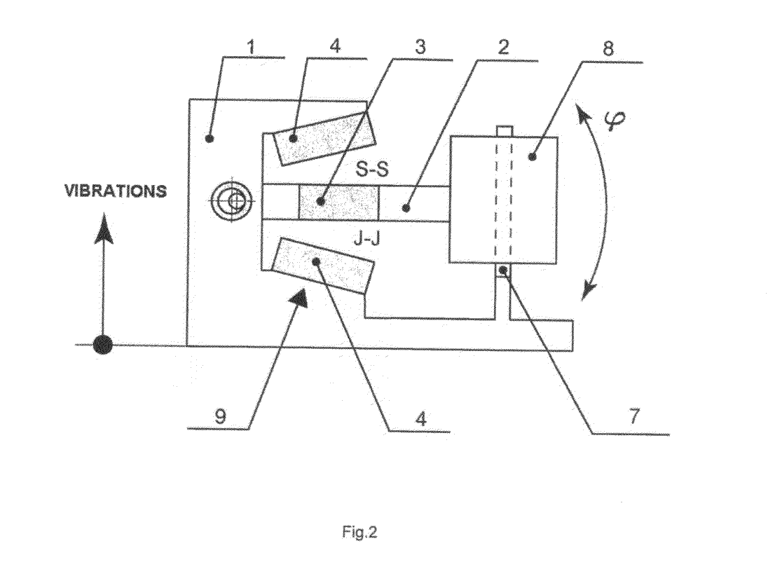

The principle of invention consists in the structure of electromagnetic vibratory generator using the low dominant frequency of vibrations up to 50 Hz (according to the size possibly up to 100 Hz) for generating of electric energy, at which is as flexible member of resonance mechanism used the set of fixed and movable permanent magnets 4, 3, 4 with mutual identical polarity as it is schematically represented in the FIG. 2. The working frequency of vibratory generator is given by a ratio of created magnetic stiffness and the weight (moment of inertia) of the whole movable member. Technical solution of this electromagnetic vibratory generator is suitable for low surrounding vibrations with frequency up to 50-100 Hz, thanks to a soft stiffness characteristics performed by a set of repulsing fixed and movable permanent magnets 4, 3, 4. In combination with weight (possible with the moment of inertia) of the whole movable member of vibratory generator the required resonance frequency (natural frequency) of the vibratory generator is tune up, which is identical with frequency of exciting vibrations. Suitability of maximum working frequency depends on the size of vibratory generator, in other words on the required power and the size of exciting vibrations

The stiffness of the flexible member 9 of the resonance mechanism of vibratory generator is created by the repulsive fixed and movable permanent magnets 4, 3, 4. These magnets are turned one to another with the identical poles and they provide the repulsive magnetic force. The most suitable are the permanent magnets made of noble earth NdFeB, which at even small dimensions provide a sufficient stiffness of mechanism. The movable permanent magnet(s) 3 is fixed to the movable generator member 2 and it is repelled by magnetic forces from the fixed permanent magnet 4 fixed in the frame 1 of generator. On each side of the movable permanent magnet 3 positioned on the movable member 2, is in the frame positioned the fixed permanent magnet 4. On the movable member 2 and also on the frame 1 it is possible to fix even several movable and fixed permanent magnets of required shape for obtaining the required stiffness characteristics of resonance mechanism, in other words of the required working frequency. The shape, size and manner of fixing of all magnets is based on the required stiffness characteristics, on the maximum excited amplitudes of the movable member 2 and the whole structure of mutually repulsing fixed and movable magnets 4, 3, 4 is adjusted to the total design of vibratory generator.

Mechanical guiding of me movable member 2 is performed by means of the hinge 6 of mounting, fixed to the movable member 2, in the case 5. Only line or spot contact occur here, and on such mounted movable member 2 act very small mechanical damping forces, i.e. friction in contact of the parts, which is the case 5 and the hinge 6. Such mounted movable member 2 enables to use also very low intensities of vibration for excitation of relative movement and thus for generating the useful output power.

Resonance mechanism of vibratory power generator consists of:
The flexible member, consisting of suitably positioned and shaped fixed and movable permanent magnets 4, 3, 4.
The movable member 2, on which are fastened movable magnets 3, the hinge 6 and the excitation circuit 8. The movable part of vibratory generator created in this way forms the effective mass, expressed by a moment of inertia, which oscillates with a relative movement towards the frame 1 at excitation of vibrations.
The frame 1, which transfers the exciting vibrations to the movable member 2 with use of magnetic stiffness of fixed permanent magnets 4 in combination with the movable magnet 3, on the movable member 2. In the frame 1 there is mounted the case 5, in which the hinge 6 is rolling/turning together with the movable member 2.

The hinge 6 of the movable member 2 is mounted in the case 5 in line or spot contact, which reduces mechanical damping forces to minimum and allows the vibratory generator to obtain the highest power. This line or spot contact depends on the structural variation of the parts, which are the case 5 and the hinge 6, and it is in balanced and not excited position of the movable member 2 pressed by magnetic forces, arising through the suitably positioned magnets 4, 3, 4 and through their shape and size to the case 5 in direction of centrifugal force of the excited movable member 2. This force should not be too high and it should only maintain the required contact of the case 5 and of the hinge 6. At the oscillating movement, excited by vibrations, of the movable member 2 arises also the centrifugal force, which is acting on this line (spot) contact of the case 5 and the hinge 6.

Combination of fixed and movable permanent magnets 4, 3, 4 creates also forces in direction of line mounting. The structure of permanent magnet/s 3 fixed to the movable member 2 is designed suitably with respect to the fixed magnets 4 so as to maintain the movable member 2 and all parts fixed to this member in equilibrium in direction of the line contact of the hinge 6 and the case 5. On the frame 1, are for a case of falling off the movable member 2 from this equilibrium between the cases 5 positioned the seating faces of a sliding material, which together with the magnetic forces maintain the movable member 2 in equilibrium with respect to the cases 5. This sliding seating faces, if they are engaged, also reduce sensitivity of the vibratory generator to surrounding vibrations.

The fixed and movable permanent magnets 4, 3, 4 creating the flexible member of resonance mechanism also determine the maximum amplitude of oscillating movement of the movable member 2 with the excitation circuit 8. Suitably geometrically designed shape of the movable magnet 3 towards the fixed magnet 4 determines the maximum oscillation amplitude of the movable member 2. At maximum approach of the magnet 3 to the fixed magnet 4 arises great magnetic force, which has the function of a soft contactless stop. Thanks to this structural solution the excitation circuit 8 does not hit the frame 1 and/or the coil 7, this impact would have a destructive character with respect to the function of vibratory generator, at a short-term increasing of amplitude of vibrations, which are very frequent at the real technical systems. Nevertheless the mechanical stop of excitation circuit 8 toward the frame 1 must be included because of overloading by the peak impacts of a very high acceleration, when this magnetic force may be overcame followed by an impact of some functional parts of vibratory generator that could have adverse consequences to service lifetime of the whole system.

Structure of the coil 7 is designed according to the required size of induced voltage (of length of wire), according to the dimensional limitation of vibratory generator, size of the excited oscillating movement of the movable member 2 with the excitation circuit 8, but in dependence on the size of connected resistance loading. Parameters of the coil 7, here it is the diameter of the used wire and the number of coil windings, together with the size of resistance load substantially affect the electromagnetic damping, which must be for generating of the maximum power adjusted to the total mechanical damping of resonance mechanism of generator.

Positioning of the coil 7 and thus also its shape and the shape of air gap in excitation circuit 8 depends on dimensional possibilities of the vibratory generator and on the maximum size of the excitation circuit being adjusted to the parameters of resonance mechanism. The coil 7 may be positioned horizontally, longitudinally, or vertically with respect to the movable member 2. The coil may be of any shape, which results from the mutual structure of the coil 7, excitation circuit 8 and its excited oscillating movement. Positioning of the coil depends on harmonising of input and designed parameters of vibratory generator. Advantageous for turning movement of the movable member 2 and of the excitation circuit 8 is usage of the vertical position of the coil which is shaped with respect of radius of turning of the excitation circuit 8.

It is recommended to use the structure of self-supporting coil without a core. If the coil with core is used, the magnetic attachment forces from magnets positioned in the excitation circuit with respect to the coil-core are considerable and are caught in contact of the case 5 and the hinge 6 and they create greater friction forces, i.e. greater mechanical damping forces, and they substantially reduce sensitivity of the vibratory generator to the exciting vibrations.

To the movable member 2 is attached the magnetic excitation circuit 8, which thanks to its excited movement toward the coil 7 induces an electromotive voltage and to the generator connected resistance load withdraws the output power. The member 8 consists of:
One or more permanent magnets, the best if rare-earth magnets (e.g. FeNdB) are used.
One or more pole pieces.

The simplest excitation circuit 8 consists of one permanent magnet 83 only which together with movable member 2 oscillates relatively toward the coil 7.

Generally many structural variants for arrangement of permanent magnets, pole pieces and the coil or of several coils may be thought out.

The whole structure and positioning of the excitation circuit 8 as a whole and the coil 7 is designed suitably with respect to the required dimensions of vibratory generator and to the excited relative movement of the movable member 2 at the given intensity of exciting vibrations and sensitivity of resonance mechanism as a whole. The excitation circuit 8 forms the substantial effective mass in resonance mechanism and at making out the design of the resonance mechanism it is necessary to consider the presumed dimensions and parameters of excitation circuit 8 and vice versa. At making out the design of structure of the excitation circuit 8 and design of the coil 7 it is necessary to consider the presumed dimensions and parameters of resonance mechanism and to adjust the design of structure to the predicted amplitude of excited oscillating movement, which the resonance mechanism will provide under loading of given vibrations and at the required value of power taken from the system.

Exact concept of parameters of the whole structure and the structural arrangement of especially excitation circuit 8 and of the coil 7 must be performed simultaneously with concept of all members of vibratory generator, because individual parameters of vibratory generator are in a mutual interaction.

Upon excitation by vibrations the movable member 2 with the magnetic excitation circuit 8 moves relatively toward the fixed coil 7 attached to the frame of generator. Thanks to the suitable structure of excitation circuit 8 and of the coil 7 the relative excited movement causes sufficient time change of magnetic flux through the coil winding and thus inducing electromotive voltage in coil winding.

The whole structure of vibratory generator may be of inverse arrangement, when the coil 7 may be attached to the movable member 2 and will move relatively toward the excitation circuit 8 attached to the frame 1. The structure of vibratory generator may be of a combined arrangement of the preceding cases, when a part of the excitation circuit 8 is movable and a part attached to the frame 1.

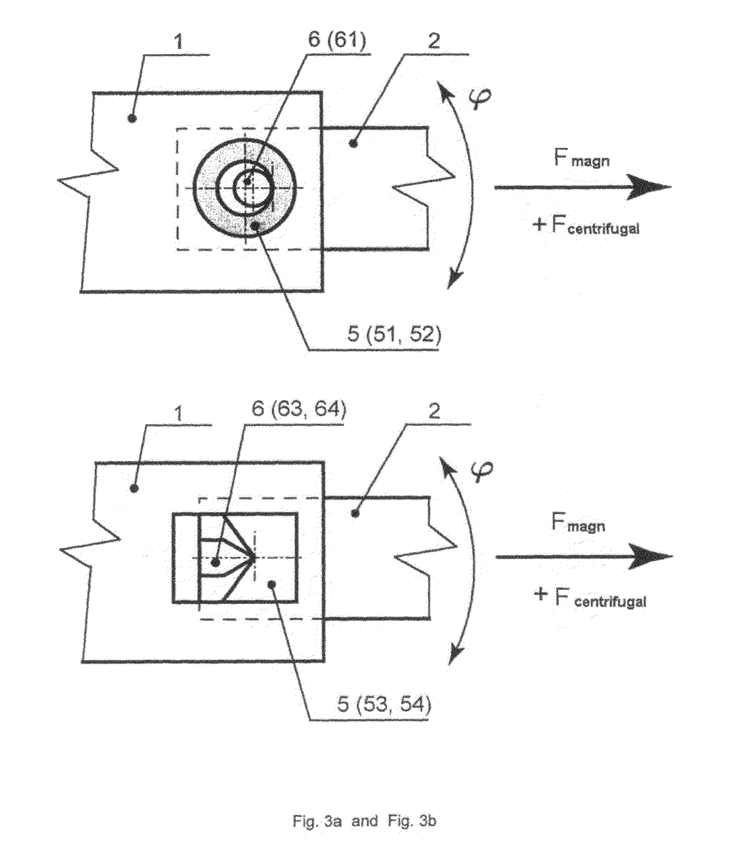

As it is apparent from the entire description of electromagnetic vibratory generator, it is a very complex technical system, which uses the concept of the structure of resonance mechanism with utilisation of magnetic flexible member, as it is obvious from the FIGS. 3a and 3b. The structure of the coil 7 and of the excitation circuit 8 substantially depends on the input parameter, power, maximum size, weight, frequency and amplitude of vibrations. Practically this mounting of the movable member 2 may be performed through several methods in arrangement of the hinge 6 in the case 5. The cylindric pin 61 rolled in the cylindric box 51. The cylindric pin 6 rolled in the tapered socket 52. The edge 63 mounted in the case 5 with groove. Tip(s) 64 mounted in the case 5 with dent and/or in the case with groove 5. Sensitivity of vibratory generator then depends on the used materials and geometry of parts of the case 5 and the cylindric pin 6. Due to this reason for the particular input parameters the structure of the coil 7 and of the excitation circuit 8 must be constructed directly to meet these requirements, a different suitable structure of the coil 7 and of the excitation circuit 8 corresponds to each input parameter, at the same time adjusted to parameters of the resonance mechanism of vibratory generator.

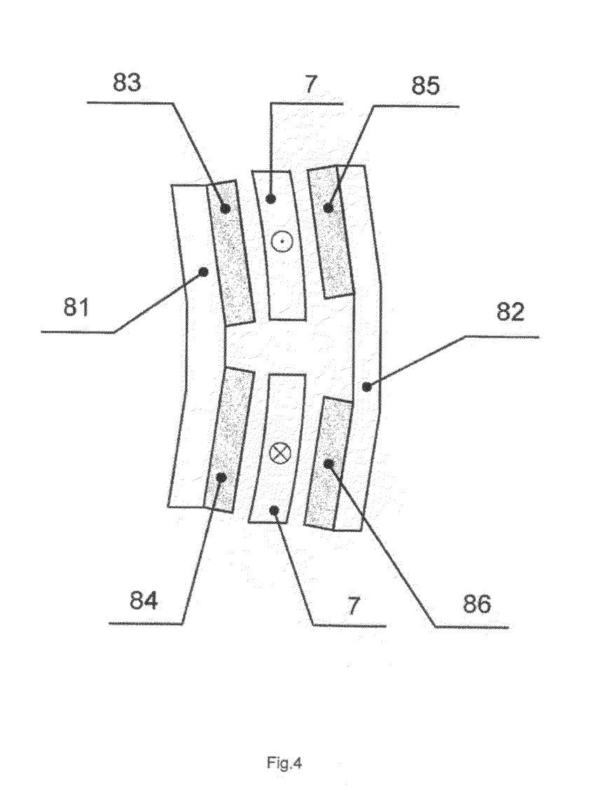

One of the advantageous structural embodiments of excitation circuit 8 and of the coil 7 is represented in the FIG. 4. The excitation circuit 8 comprises 4 permanent magnets 83, 84, 85 and 86 positioned on the inner pole piece 81 and on the outer pole piece 82. Opposite laying magnets are magnetised in identical direction and so they create in the air gap between them a sufficiently great magnetic field in the place of positioning of coil winding 7. Magnetic flux is closed via the inner pole piece 81 and the outer pole piece 82. These pole pieces have a shape corresponding to radius of movement of the movable member 2 in the place of positioning of the coil 7. The coil 7 has a shape of rectangular self-supporting coil without core. Structure of this coil 7 is shaped according to already mentioned radius of movement and the oscillating excitation circuit 8 in a whole range of oscillating movement creates the maximum magnetic flux through the fixed coil 7. This structure does not permit even at the extreme excited movement contact of the excitation circuit 8 and of this coil 7, and at overloading of generator damage of coil winding 7 may not occur.

Function of the above described electromagnetic vibratory generator is following: the movable member 2 with the movable permanent magnet(s) 3 is positioned between the fixed permanent magnets 4 attached in the frame 1 of vibratory generator, so that the movable permanent magnet 3 and the fixed permanent magnets 4 produce among each other the repulsive magnetic forces, which create stiffness of the vibratory generator (repulsive magnets form the flexible member). Oscillating movement of the movable member 2 with excitation circuit 8 is provided by excitation by vibrations of the given frequency, to which the generator is tuned up. The tuned up resonance frequency (natural frequency) is given by ratio of stiffness of the magnetic flexible member 9 and weight (moment of inertia) of the movable member 2 with the excitation circuit 8.

The principle of generating the electric energy consists in movement of excitation circuit 8 toward the coil 7. Oscillation movement of the movable member 2 with excitation circuit 8 is provided by exciting vibrations of the given frequency, to which the generator is tuned. This oscillating movement induces in the coil 7 electromotive voltage and at connection of electric load R_{z} to terminals of the coil 7 current passes through the load and by the connected electric load R_{z} electric output power is taken off.

### INDUSTRIAL APPLICABILITY

Electromagnetic vibratory generator for harvesting electric energy from mechanic vibrations, kinetic energy of oscillating movement generally, having frequency of up to 50 Hz; (In extreme cases up to 100 Hz) may be used for harvesting electric energy from mechanical vibrations (oscillating movement generally) and for power supply of an autonomous device and the wireless sensors without necessity of external power supply or without usage of the primary or secondary battery. Usage of this device is suitable also for power supply of wireless sensors and other applications in embedded structures and constructions without usage, of supply of electric energy or galvanic cells and batteries.

### LIST OF REFERENTIAL MARKINGS

1 frame of electromagnetic vibratory generator
2 movable member
3 movable permanent magnet/s
4 fixed permanent magnets
5 case of mounting
51 cylindric box
52 tapered socket
53 case with groove
54 case with dent
6 hinge of mounting
61 cylindric pin
62 edge
63 tip
7 coil
8 excitation circuit
81 inner pole piece
82 outer pole piece
83 permanent magnet
84 permanent magnet
85 permanent magnet
86 permanent magnet
9 magnetic flexible member

1. Arrangement of electromagnetic vibratory generator for generation of electric energy comprising the movable member (2) and the flexible member (9) arranged to the frame (1), excitation circuit (8) attached to the movable member (2) and the coil (7), while the coil (7) and the excitation circuit (8) are moveably arranged one towards the other in a way so that the magnetic field of at least one permanent magnet (83) is capable to induce voltage in the coil (7), characterised in that, it has the flexible member (9) formed of fixed permanent magnets (4) attached in the frame (1) and of one or more movable permanent magnets (3) attached to the movable member (2) with the excitation circuit (8) provided with the hinge (6) mounted in the case (5), while the excitation circuit (8) is formed of at least one permanent magnet (83) arranged on at least one pole piece (81), for creation of magnetic flux through the coil (7), at the same time the coil (1) is in static manner arranged on the frame (1) towards the excitation circuit (8), around which this moves transversably or vice versa.

2. Arranged of electromagnetic vibratory generator for generation of electric energy according to the claim 1, characterised in that, the flexible member formed of fixed permanent magnets (4) attached in the frame (1) and of one or more movable permanent magnets (3), while mutual position of fixed and movable permanent magnets (3 and 4) provides a contact force of the case (5) toward the hinge (6).

3. Arrangement of electromagnetic vibratory generator for generation of electric energy according to the claim 1, characterised in that, the hinge (6) is performed as the cylindric pin (61) being rolled in the cylindric box (51).

4. Arrangement of electromagnetic vibratory generator for generation of electric energy according to the claim 1, characterised in that, the hinge (6) is performed as the cylindric pin (61) being rolled in the tapered socket (52).

5. Arrangement of electromagnetic vibratory generator for generation of electric energy according to the claim 1, characterised in that, the hinge (6) is performed as the edge (63) mounted in case (52) with groove.

6. Arrangement of electromagnetic vibratory generator for generation of electric energy according to the claim 1, characterised in that, the hinge (6) is performed as the tip (64) mounted in the case (52) provided with dent or groove.
